(19) United States
(12) Patent Application Publication
(10) Pub. No.: US 2026/0214345 A1
(43) Pub. Date: Jul. 23, 2026

(54) AUTO-EXPOSURE PRECOGNITION

(71) Applicant: SAMSUNG ELECTRONICS CO., LTD., Suwon-si (KR)

(72) Inventors: Gal BITAN, Tel-Aviv (IL); Oded Lichay MONZON, Tel-Aviv (IL)

(73) Assignee: SAMSUNG ELECTRONICS CO., LTD., Suwon-si (KR)

(21) Appl. No.: 19/029,921

(22) Filed: Jan. 17, 2025

(51) Int. Cl. H04N 23/73; H04N 23/69; H04N 23/90; H04N 23/95

(52) U.S. Cl. CPC H04N 23/73; H04N 23/69; H04N 23/90; H04N 23/95

(57) ABSTRACT

The present disclosure provides methods, apparatuses, systems, and computer-readable mediums for performing auto-exposure precognition by an apparatus. A method includes obtaining a first frame, predicting a second frame subsequent to the first frame, obtaining image information corresponding to the second frame, extracting auto-exposure information corresponding to the second frame from the image information, and capturing the second frame using the auto-exposure information.

### BACKGROUND

### 1. Field

The present disclosure relates generally to image capture, and more particularly to methods, apparatuses, systems, and non-transitory computer-readable mediums for performing auto-exposure precognition.

### 2. Description of Related Art

Image sensors may be widely installed on mobile devices and/or other electronic devices. Alternatively or additionally, image sensors may be used in other non-mobile applications such as, but not limited to, surveillance cameras, traffic monitoring cameras, or the like. Electronic devices may contain multiple image sensors (e.g., still cameras, video cameras, or the like). For example, a typical configuration for an electronic device containing multiple image sensors may include an electronic device having two or more image sensors in which a field-of-view (FoV) of a particular image sensor is greater than another FoV of another image sensor of the same mobile device.

Automatic exposure (AE) may be a feature available in image sensors, and/or electronic devices and systems containing image sensors, that may provide an automatic operation mode. For example, an AE algorithm may adjust one or more image capture conditions (e.g., exposure time, shutter speed, sensor gain, or the like) for one or more frames to be captured based on information collected from previously captured frames. That is, the AE algorithm may collect statistics from an incoming image stream and adapt exposure parameters in order to optimize capture of subsequent images. Consequently, the AE algorithm may only respond to scene changes (e.g., appearance of new objects) after the changes have occurred, which may cause one or more images to be captured at an improper exposure. For example, in a case where objects in a scene that may significantly affect the optimal exposure of a given frame are not included in a previous frame (e.g., due to motion of the image sensor and/or the objects), the AE algorithm may need to hunt for (e.g., estimate and/or predict) a proper exposure during several subsequent frames after the appearance of the objects, which may result in one or more of the subsequent frames being poorly exposed.

Thus, there exists a need for further improvements to AE algorithms, as the need to provide optimally exposed images may be constrained by having to hunt for a proper exposure when responding to scene changes. Improvements are presented herein. These improvements may also be applicable to other image capture and/or processing technologies and the standards that employ these technologies.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, systems, and non-transitory computer-readable mediums for performing auto-exposure precognition are provided by the present disclosure.

According to an aspect of the present disclosure, a method for performing auto-exposure precognition by an apparatus includes obtaining a first frame, predicting a second frame subsequent to the first frame, obtaining image information corresponding to the second frame, extracting auto-exposure information corresponding to the second frame from the image information, and capturing the second frame using the auto-exposure information.

According to an aspect of the present disclosure, an apparatus for performing auto-exposure precognition includes a memory storing instructions, and one or more processors communicatively coupled to the memory. The instructions are configured to, when individually or collectively executed by the one or more processors, cause the apparatus to obtain a first frame, predict a second frame subsequent to the first frame, obtain image information corresponding to the second frame, extract auto-exposure information corresponding to the second frame from the image information, and capture the second frame using the auto-exposure information.

According to an aspect of the present disclosure, an apparatus for performing auto-exposure precognition includes means for obtaining a first frame, means for predicting a second frame subsequent to the first frame, means for obtaining image information corresponding to the second frame, means for extracting auto-exposure information corresponding to the second frame from the image information, and means for capturing the second frame using the auto-exposure information

According to an aspect of the present disclosure, a non-transitory computer-readable storage medium storing computer-executable instructions for performing auto-exposure precognition by a device is provided. The computer-executable instructions, when executed individually or collectively by at least one processor of the device, cause the device to obtain a first frame, predict a second frame subsequent to the first frame, obtain image information corresponding to the second frame, extract auto-exposure information corresponding to the second frame from the image information, and capture the second frame using the auto-exposure information.

According to an aspect of the present disclosure, an electronic device includes an imaging sensor, a memory, and one or more processors communicatively coupled to the imaging sensor and to the memory. The imaging sensor is configured to obtain a first frame, predict a second frame subsequent to the first frame, and obtain image information corresponding to the second frame. The instructions are configured to, when individually or collectively executed by the one or more processors, cause the electronic device to obtain, from the imaging sensor, the first frame and the image information, extract auto-exposure information corresponding to the second frame from the image information, and capture, using the imaging sensor, the second frame using the auto-exposure information.

Additional aspects are set forth in part in the description that follows and, in part, may be apparent from the description, or may be learned by practice of the presented embodiments of the disclosure.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 illustrates a block diagram of a camera module, in accordance with various aspects of the present disclosure;

FIG. 2 depicts a block diagram of an image sensor, in accordance with various aspects of the present disclosure;

FIG. 3 illustrates an example of a process flow for performing auto-exposure precognition, in accordance with various aspects of the present disclosure;

FIG. 4 depicts an example of a block diagram for performing auto-exposure precognition, in accordance with various aspects of the present disclosure;

FIGS. 5A to 5C illustrate an example of performing auto-exposure precognition, in accordance with various aspects of the present disclosure;

FIG. 6 depicts a block diagram of an example apparatus for performing auto-exposure precognition, in accordance with various aspects of the present disclosure; and

FIG. 7 illustrates a flowchart of an example method for performing auto-exposure precognition, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it is to be apparent to those skilled in the art that these concepts may be practiced without these specific details. In some instances, well known structures and components are shown in block diagram form in order to avoid obscuring such concepts. In the descriptions that follow, like parts are marked throughout the specification and drawings with the same numerals, respectively.

The following description provides examples, and is not limiting of the scope, applicability, or embodiments set forth in the claims. Changes may be made in the function and/or arrangement of elements discussed without departing from the scope of the present disclosure. Various examples may omit, substitute, or add various procedures or components as appropriate. For example, the methods described may be performed in an order different from that described, and various steps may be added, omitted, and/or combined. Alternatively or additionally, features described with reference to some examples may be combined in other examples.

Various aspects and/or features may be presented in terms of systems that may include a number of devices, components, modules, or the like. It is to be understood and appreciated that the various systems may include additional devices, components, modules, or the like and/or may not include all of the devices, components, modules, or the like discussed in connection with the figures. A combination of these approaches may also be used.

As a general introduction to the subject matter described in more detail below, aspects described herein are directed towards apparatuses, methods, systems, and non-transitory computer-readable mediums for performing auto-exposure precognition. Aspects presented herein may provide for predicting a next frame and/or image to be captured by an image sensor in order to potentially reduce and/or avoid subsequently capturing poorly exposed frames and/or images.

Notably, aspects presented herein may provide for extracting exposure information from the predicted next frame and/or image and adjusting an exposure configuration of the image sensor based on the exposure information. In such a manner, an AE algorithm may adjust exposure parameters of an image sensor in anticipation of luminosity changes that may not affect the currently captured image and/or frame. That is, the AE algorithm may adjust the exposure parameters of the image sensor prior to an appearance of one or more objects that may significantly affect the exposure of subsequent frames and/or images.

Advantageously, the auto-exposure precognition described herein may significantly reduce and/or prevent a need to hunt for a proper exposure, and as such, may reduce and/or prevent capturing poorly exposed images due to sudden exposure changes, when compared to related AE algorithms.

Although the present disclosure describes the use of auto-exposure precognition in conjunction with an electronic device having two (2) image sensors (e.g., cameras), the present disclosure is not limited in this regard. For example, the concepts described herein may be applied to other use cases, such as, but not limited to, an electronic device having one (1) image sensor or having three (3) or more image sensors.

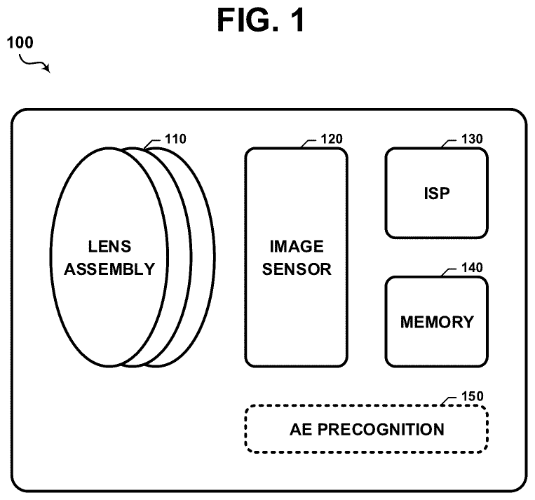

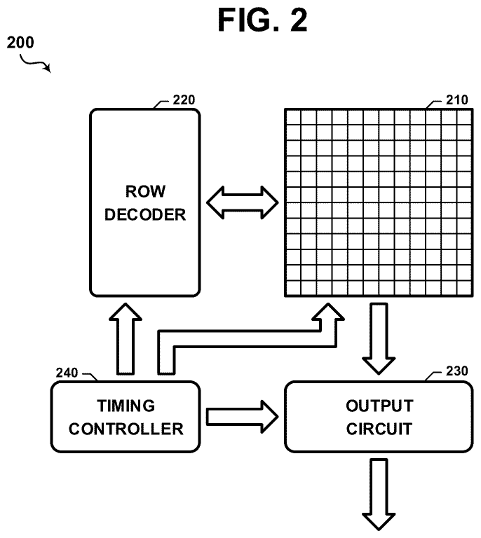

As noted above, certain embodiments are discussed herein that relate to performing auto-exposure precognition. Before discussing these concepts in further detail, however, examples of camera modules and image sensors that may be used in implementing and/or otherwise providing various aspects of the present disclosure are discussed with reference to FIGS. 1 and 2.

FIG. 1 is a block diagram illustrating a camera module, in accordance with various aspects of the present disclosure. Referring to FIG. 1, the camera module 100 may include a lens assembly 110, an image sensor 120, an image signal processor (ISP) 130, a memory 140 (e.g., a buffer memory, or the like), and/or the auto-exposure precognition component 150.

The lens assembly 110 may concentrate light emitted from a subject that may be an object of image photographing. The lens assembly 110 may include one or more optical lenses. The lens assembly 110 may include a path switching member that may deflect the path of light to face the image sensor 120. Depending on the arrangement of the path switching member and the arrangement form with the optical lens, the camera module 100 may have a vertical form or a folded form. The camera module 100 may include a plurality of lens assemblies 110, and in such a case, the camera module 100 may be, but may not be limited to, a dual camera, a 360 degree (360°) camera, a spherical camera, or the like. Some of the plurality of lens assemblies 110 may have the same lens attributes (e.g., view angle, focal distance, automatic focus, f-stop number, optical zoom, or the like) and/or different lens attributes. For example, the lens assembly 110 may include, but not limited to, a wide-angle lens, an ultra-wide angle lens, and/or a telephoto lens. However, the present disclosure is not limited in this regard, and the lens assembly 110 may include less lenses (e.g., two (2) or less), more lenses (e.g., four (4) or more), or different lenses (e.g., a zoom lens, a macro lens, or the like).

That is, the lens assembly 110 may include a plurality of lenses having different focal lengths and/or FoV angles. For example, the lens assembly 110 may include a wide-angle lens having a focal length from about 16 millimeters (mm) to about 35 mm and/or a diagonal FoV from about 64 degrees (°) to about 108°. As another example, the lens assembly 110 may include an ultra-wide angle lens having a focal length from about 14 millimeters (mm) to about 24 mm and/or a diagonal FoV from about 84 degrees (°) to about 114°. As another example, the lens assembly 110 may include a telephoto lens having a focal length from about 70 millimeters (mm) to about 200 mm and/or a diagonal FoV from about 12 degrees (°) to about 34°. However, the present disclosure is not limited in this regard, and the lens assembly 110 may include other lenses having different focal length and/or diagonal FoVs.

At least some of the optical lenses and/or the path switching members constituting the lens assembly 110 may be configured to be moved. For example, the optical lens may move along the optical axis and the distance between adjacent lenses may be adjusted by moving at least part of the optical lenses included in the lens assembly 110, thereby adjusting the optical zoom ratio.

In an embodiment, the position of any one optical lens included in the lens assembly 110 may be adjusted so that the image sensor 120 may be located at the focal length of the lens assembly 110.

The image sensor 120 may obtain an image corresponding to a subject by converting light emitted and/or reflected from the subject and transmitted through the lens assembly 110 into an electrical signal.

The image sensor 120 may be equipped with a color separation lens array, and each pixel may include a plurality of light sensing cells that form a plurality of channels, for example, a plurality of light sensing cells arranged in a 2×2 matrix. Some of these pixels may be used as auto-focus (AF) pixels, and the image sensor 120 may generate AF driving signals from signals from the plurality of channels in the AF pixels.

The memory 140 may store some or all data of the image acquired through the image sensor 120 for the next image processing operation. For example, when a plurality of images are acquired at a relatively high speed, the acquired original data (e.g., Bayer patterned data, high-resolution data, or the like) may be stored in the memory 140, and only low-resolution images may be displayed, and the original data of the selected image may be transmitted to the ISP 130. The memory 140 may be integrated into the ISP 130 and/or may be configured as a separate memory that may be operated independently.

The ISP 130 may perform image processing on the image acquired through the image sensor 120 and/or image data stored in the memory 140. The image processing may include, but not be limited to, depth map generation, three-dimensional (3D) modeling, panoramic generation, feature point extraction, image synthesis, and/or image compensation (e.g., noise reduction, resolution adjustment, brightness adjustment, blurring, sharpening, softening, or the like). The ISP 140 may perform control (e.g., exposure time control, read-out timing control, or the like) on components (e.g., the image sensor 120, the auto-exposure precognition component 150, or the like) included in the camera module 100. The image processed by the ISP 130 may be stored again in the memory 140 for further processing and/or may be provided to external components of the camera module 100.

In some embodiments, the camera module 100 may include the auto-exposure precognition component 150, which may be configured to perform auto-exposure precognition. For example, the auto-exposure precognition component 150 may be configured to obtain a first frame from image sensor 120, predict a second frame subsequent to the first frame, obtain image information corresponding to the second frame, extract auto-exposure information corresponding to the second frame from the image information, and capture the second frame using the auto-exposure information. As another example, the camera module 100 may be configured to obtain a first frame from image sensor 120, predict a second frame subsequent to the first frame, and obtain image information corresponding to the second frame. In such an example, the camera module 100 may provide the first frame and the image information corresponding to the second frame to an external device (e.g., a desktop computer, a computer server, a virtual machine, a network appliance, a mobile device (e.g., a user equipment (UE), a laptop computer, a tablet computer, a PDA, a smart phone, any other type of mobile computing device, or the like), a camera (e.g., a still camera, a video camera, an ultra-wide camera, a time-of-flight (TOF) camera, or the like), a wearable device (e.g., smart watch, headset, headphones, glasses, or the like), a smart device (e.g., a voice-controlled virtual assistant, a set-top box (STB), a refrigerator, an air conditioner, a microwave, a television (TV), or the like), an Internet-of-Things (IoT) device, and/or any other type of data processing device).

The image sensor 120, according to example embodiments, may be applied to various electronic devices. The image sensor 120, according to example embodiments, may be applied to a mobile phone or a smartphone, a tablet or a smart tablet, a digital camera or camera recorder (e.g., a camcorder), a laptop computer, a television, a smart television, or the like. For example, the smartphone or smart tablet may include a plurality of high-resolution cameras each equipped with a high-resolution image sensor. High-resolution cameras may be used to extract depth information from subjects in the image, adjust the out-focusing of the image, or automatically identify subjects in the image.

Alternatively or additionally, the image sensor 120 may be applied to a smart refrigerator, a security camera, a robot, a medical camera, or the like. For example, a smart refrigerator may automatically recognize food in the refrigerator using an image sensor and inform the user of the presence of a specific food, the type of food received or taken out, or the like through a smartphone. Security cameras may provide ultra-high-resolution images and may use high sensitivity to recognize objects or people in the images even in dark environments. Robots may be deployed at a disaster or industrial site to which people do not directly access to provide high-resolution images. Medical cameras may provide high-resolution images for diagnosis or surgery and may dynamically adjust the field of view.

Alternatively or additionally, the image sensor 120 may be applied to vehicles. The vehicle may include a plurality of vehicle cameras arranged at various positions. Each vehicle camera may include an image sensor 120, according to an example embodiment. The vehicle may provide the driver with various information about the inside or surroundings of the vehicle using the plurality of vehicle cameras, and may automatically recognize objects or people in the image to provide information necessary for autonomous driving.

FIG. 2 depicts a block diagram of an image sensor, in accordance with various aspects of the present disclosure. Referring to FIG. 2, the image sensor 200 may include a pixel array 210, a row decoder 220, an output circuit 230, and/or a timing controller 240. The image sensor 200 of FIG. 2 may include and/or may be similar in many respects to the image sensor 120 described above with reference to FIG. 1, and may include additional features not mentioned above. Consequently, repeated descriptions of the image sensor 200 described above with reference to FIG. 1 may be omitted for the sake of brevity.

The image sensor 200 may be and/or may include a charge coupled device (CCD) image sensor and/or a complementary metal oxide semiconductor (CMOS) image sensor. However, the present disclosure is not limited in this regard.

The pixel array 210 may include pixels arranged in two (2) dimensions along a plurality of rows and columns. The row decoder 220 may select one of the rows of the pixel array 210 in response to a row address signal output from the timing controller 240. The output circuit 230 may output a light sensing signal in units of columns from a plurality of pixels arranged along the selected row. In an embodiment, the output circuit 230 may include a column decoder and an analog to digital converter (ADC) for outputting the light sensing signals. For example, the output circuit 230 may include a plurality of ADCs placed on each column between the column decoder and the pixel array 210. As another example, the output circuit 230 may include an ADC placed on the output end of the column decoder. The timing controller 240, the row decoder 220, and the output circuit 230 may be implemented as one chip or as respective separate chips.

In an embodiment, the ISP 130 of FIG. 1 may be configured to process the light sensing signals provided by the output circuit 230. Alternatively or additionally, the ISP 130, the timing controller 240, the row decoder 220, and the output circuit 230 may be implemented as one chip or as respective separate chips.

The pixel array 210 may include a plurality of pixels that may sense light of different wavelengths. The arrangement of pixels may be implemented in various ways. For example, each pixel of the pixel array 210 may be located behind a corresponding color filter, and consequently, each pixel may output a value (or level) corresponding to a RAW intensity (e.g., light intensity, brightness, photon count, or the like) of the corresponding filter color (e.g., red, green, or blue). That is, the image sensor 200 may output a single color value for each pixel of the pixel array 210. Alternatively or additionally, the color filters may be arranged in a repeating mosaic pattern that may be referred to as a Bayer pattern (e.g., a 1×1 or single Bayer pattern, a 2×2 or quad-Bayer pattern, a 3×3 or nona-Bayer pattern, a Q×Q Bayer pattern, or the like). However, the present disclosure is not limited in this regard, and the color filters of the pixel array 210 may be arranged in various ways without departing from the scope of the present disclosure.

Having discussed examples of a device, electronic devices, and image sensors that may be used in providing and/or implementing various aspects of the present disclosure, a number of embodiments are now discussed in further detail. In particular, and as introduced above, some aspects of the present disclosure generally relate to performing auto-exposure precognition. For example, according to one or more embodiments of the present disclosure may provide for predicting a next frame and extracting statistics related to the predicted frame and adjusting an exposure configuration of an image sensor based on the extracted statistics. Accordingly, embodiments of the present disclosure may provide for potentially reducing and/or preventing hunting (e.g., estimating, predicting) of an auto-exposure configuration in subsequent frames.

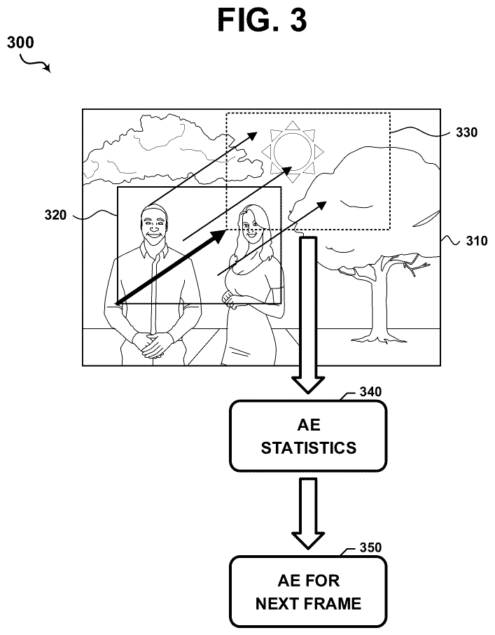

FIG. 3 illustrates an example of a process flow for performing auto-exposure precognition. Referring to FIG. 3, a process flow 300 for performing auto-exposure precognition by a device (e.g., the camera module 100) that implements one or more aspects of the disclosure is illustrated. In some embodiments, at least a portion of the process flow 300 may be performed by a device, which may include the auto-exposure precognition component 150. Alternatively or additionally, another computing device (e.g., a server, a laptop, a smartphone, a UE, a camera, a wearable device, a smart device, an IoT device, or the like) that includes the auto-exposure precognition component 150 may perform at least a remaining portion of the process flow 300. For example, in some embodiments, the device and the other computing device may perform the process flow 300 in conjunction. That is, the device may perform a portion of the process flow 300 and a remaining portion of the process flow 300 may be performed by one or more other computing devices.

As shown in FIG. 3, the process flow 300 may include obtaining (e.g., receiving, acquiring, accessing, capturing, or the like) a first frame 320. In an embodiment, the obtaining of the first frame 320 may include capturing an image using a first (or main) camera of a device (e.g., the camera module 100). In an optional or additional embodiment, the obtaining of the first frame 320 may include capturing two or more images using the first camera as part of an input image burst. For example, the device may capture an input image burst that includes K images, where K is a positive integer greater than one (1), for performing a high dynamic range (HDR) operation, a motion blur estimation operation, or the like. However, the present disclosure is not limited in this regard, and the device may capture one or more images for performing various operations. For example, the first frame 320 may be obtained to provide a preview of an image prior to performing the capture of the image.

The first frame 320 may be and/or may include a red-green-blue (RGB) (e.g., color) image. Alternatively or additionally, the first frame 320 may be and/or may include other types of images such as, but not limited to, black-and-white images, or the like. In an embodiment, the first frame 320 may have been extracted from a video (e.g., a sequence of video images). The present disclosure is not limited in this regard.

In an embodiment, the first frame 320 may be captured using the first camera of the device having a first field-of-view (FoV) (e.g., a wide-angle camera and/or lens). In such an embodiment, the device may also have a second camera (e.g., an ultra-wide camera) having a second FOV greater than the first FoV that may be capable of capturing an ultra-wide (UW) image 310. For example, the first camera may have a first FoV of approximately 60 degrees and the second camera may have a second FoV of approximately 100 degrees. For example, the second FoV may be between 70 degree and 100 degree. For example, the second FoV may be greater than 100 degree.

However, the present disclosure is not limited in this regard. For example, the first frame 320 may correspond to only a portion of an entire image 310 that may have been captured by the first camera or the second camera. That is, the device may perform an in-sensor zoom (ISZ) and/or a cropping operation on the entire image 310 to obtain the first frame 320.

As further shown in FIG. 3, the process flow 300 may include predicting a second frame 330 that is subsequent to the first frame 320. That is, the second frame 330 may represent an expected next frame of the first camera that captured the first frame 320. When the first frame 320 corresponds to a portion of the entire image 310, the second frame 330 may correspond to another portion of the entire image 310. Alternatively or additionally, the second frame 330 may correspond to a portion of a UW image 310 of the second camera.

The predicting of the second frame 330 may include determining an angular motion (or velocity) of the first frame 320 and predicting a region-of-interest (ROI) of the second frame 330 based on the angular motion. The angular motion of the first frame 320 (represented in FIG. 3 by solid black arrows) may be predicted by at least one of various approaches that may include well-known approaches for determining angular motion based on images. For example, the angular motion may be determined using a simultaneous localization and mapping (SLAM) algorithm and/or a photo-SLAM (PSLAM) algorithm. As another example, the angular motion may be determined by performing an optical flow operation and/or a motion estimation operation on the first frame 320. Alternatively or additionally, the angular motion of the first frame 320 may be determined based on data acquired by one or more sensors (e.g., a gyroscope, an accelerometer) that may be installed on the camera module 100.

The location of the ROI of the second frame 330 may be estimated based on a location of the first frame 320 and the angular velocity of the first frame 320. For example, the location rₙₑₓₜ of the second frame 330 may be calculated using an equation similar to Equation 1.

$${r}_{next} = {r}_{current} + \frac{ω \times Δ t}{{i}_{FoV}} \qquad [ Eq . 1 ]$$

Referring to Equation 1, r_{current}={x₁, y₁} may represent the location of the first frame 320, ω may represent the angular velocity of the first frame 320 and may be represented in units of pixels and/or radians per second depending on a coordinate representation of the captured images, Δt may represent a time difference between the first frame 320 and the second frame 330, and troy may represent the number of radians covered by each pixel.

When a camera (e.g., the second camera, or the UW camera), other than the camera (e.g., the first camera, or the main camera) used to capture the first frame 320, is used to determine the auto-exposure configuration for the second frame 330, r_{current}={x₂, y₂} may represent the location of the first frame 320 with respect to the second camera. Consequently, the location of the first frame 320 with respect to the first camera (e.g., {x₁, y₁}) may need to be mapped to the second camera. In an embodiment, the mapping may be done using a simple pixel-to-pixel correspondence. In an optional or additional embodiment, the mapping may include transposing the coordinate system of the first camera to the coordinate system of the second camera. However, the present disclosure is not limited in this regard.

The location of the ROI of the second frame 330 may be estimated based on calculating the location of a single pixel within the ROI at a known position of the ROI (e.g., a center point, a bottom-left corner, or the like). For example, the location of the center point of the ROI of the second frame 330 may be calculated based on the center point of the first frame 320 and the angular velocity of the first frame 320. Alternatively or additionally, the location of the ROI of the second frame 330 may be estimated based on calculating the location of various pixels within the ROI using the angular velocity of the first frame 320. As another example, multiple angular velocities may be determined for various regions of the first frame 320, and the location of the ROI of the second frame 330 may be estimated based on calculating the location of various pixels within the ROI using the angular velocities of the first frame 320. That is, the present disclosure is not limited in this regard, and various points and/or pixels and their corresponding angular velocities may be used to determine the location of the ROI of the second frame 330.

As shown in FIG. 3, the second frame 330 may contain objects that do not appear in the first frame 320 that may significantly affect the optimal exposure of the second frame 330 (e.g., the sun). That is, the exposure settings used to capture the first frame 320 may not be appropriate to optimally expose the second frame 330 when the second frame 330 is captured. Consequently, the exposure configuration of the first camera may need to be adjusted to account for the new scene prior to capturing the second frame 330. Although FIG. 3 depicts an example scenario in which new objects (e.g., the sun) appear in the second frame 330 that were not present in the first frame 320 due to the movement of the image sensor, the present disclosure is not limited in this regard. That is, other scenarios in which the exposure configuration of the first frame 320 is no longer appropriate to capture the second frame 330 are applicable to the present disclosure. For example, new objects may appear in the second frame 330 due to the movement of the objects (e.g., a fast moving vehicle, or the like).

Continuing to refer to FIG. 3, the process flow 300 may include obtaining image information corresponding to the second frame, such as, but not limited to, AE statistics 340. The AE statistics 340 may include one or more parameters for an exposure configuration to be used to capture the second frame 330. For example, the AE statistics 340 may include, but not be limited to, at least one of an exposure time, a shutter speed, an aperture, a sensor gain, an International Organization for Standardization (ISO) sensitivity, a histogram of the image, or the like.

In an embodiment, the AE statistics 340 may be obtained using the second camera (e.g., the UW camera) which may be different from the first camera. Alternatively or additionally, the AE statistics 340 may be obtained using the first camera (e.g., the main camera).

In an embodiment where the first frame 320 is captured using a wide-angle lens and/or camera, the second frame 330 may be captured using an ultra-wide angle camera and/or lens that may have a larger FOV than the wide-angle lens and/or camera, and as such, may contain objects that may not be visible in the FoV of the first frame 320, and the AE statistics 340 (and the subsequent AE precognition) may be based on the objects located in the area captured by the ultra-wide angle camera and/or lens that may not be visible in the first frame 320. The objects may be out of the first FOV. Alternatively or additionally, when the first frame 320 is captured using a telephoto lens and/or camera, the second frame 330 may be captured using a wide-angle and/or an ultra-wide angle camera and/or lens that may have a larger FoV than the telephoto lens and/or camera, and as such, may contain objects that may not be visible in the FoV of the first frame 320, and the AE statistics 340 (and the subsequent AE precognition) may be based on the objects located in the area captured by the wide-angle and/or the ultra-wide angle camera that may not be visible in the first frame 320.

In an embodiment, the image sensor (e.g., image sensor 120 or image sensor 200) may provide (e.g., transmit) the entire image 310 to an application processor (e.g., ISP 130), and the processor may extract the AE statistics 340 from the portion of the entire image 310 transmitted by the image sensor that corresponds to the ROI of the second frame 330. In an optional or additional embodiment, the image sensor may include AE statistics hardware and/or software that may transmit, to the processor, only the portion of the entire image 310 that corresponds to the ROI of the second frame 330 and/or transmits, to the processor, the AE statistics 340 that correspond to the ROI of the second frame 330. As a result, aspects of the present disclosure may reduce and/or minimize an amount of data and/or a bit rate of data transmitted between the image sensor and the processor, thereby potentially reducing power consumption of the electronic device.

In addition, the AE statistics 340 may be obtained from the second camera while the second camera is operating in a reduced capability mode (e.g., an assist mode) in which the camera may only obtain the needed AE statistics 340 of the ROI of the second frame 330. For example, the second camera, when operating in the assist mode, may not generate an image of the entire FOV of the camera, but instead, may only obtain image information (e.g., a histogram, a binned readout, a low-resolution image, or the like) of the portion of the FoV of the camera corresponding to the ROI of the second frame 330. As a result, aspects of the present disclosure may further reduce and/or minimize power consumption and/or processing load of the electronic device.

As discussed above, the AE statistics 340 may be obtained from the second camera, thus, the AE statistics 340 may need to be adjusted to correspond to the first camera that may be used to capture the second frame 330. That is, the processor flow 300 may include extracting AE configuration information 350 corresponding to the second frame 330 from the AE statistics 340. In an embodiment, the extracting of the AE configuration information 350 may include adjusting the AE statistics 340 corresponding to the second camera based on differences between an auto-exposure configuration of the first camera and a second auto-exposure configuration of the second camera. For example, the AE statistics 340 may be adjusted based on a correlation between the auto-exposure configuration of the first camera and the second auto-exposure configuration of the second camera. In particular, the AE statistics 340 may be adjusted based on at least one of a difference in pixel response and/or pixel size between the first camera and the second camera, differences between the current AE configurations of the first camera and the second camera, or a difference in responsivity between the first camera and the second camera. However, the present disclosure is not limited in this regard, and the AE statistics 340 may be adjusted based on other factors.

In such a manner, the processor flow 300 may obtain the AE configuration information 350 that may be needed to optimally capture the second frame 330 using the first camera. Alternatively or additionally, the processor flow 300 may include applying the AE configuration information 350 to the first camera and capturing the second frame 330 using the first camera using the AE configuration information 350.

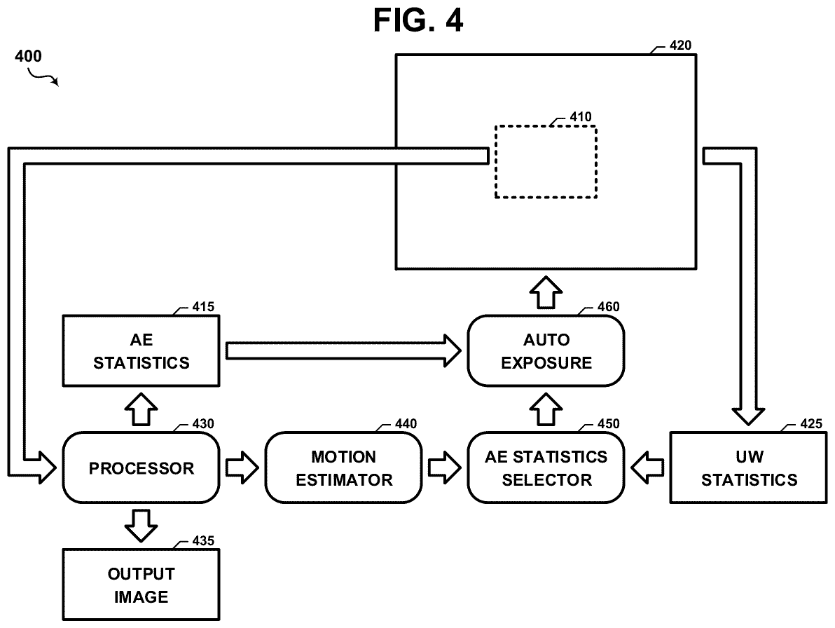

FIG. 4 depicts an example of a block diagram for performing auto-exposure precognition, in accordance with various aspects of the present disclosure. Referring to FIG. 4, a block diagram 400 for performing auto-exposure precognition by a device (e.g., the camera module 100) that implements one or more aspects of the disclosure is illustrated. In some embodiments, at least a portion of the block diagram 400 may be performed by a device, which may include the auto-exposure precognition component 150. Alternatively or additionally, another computing device (e.g., a server, a laptop, a smartphone, a UE, a camera, a wearable device, a smart device, an IoT device, or the like) that includes the auto-exposure precognition component 150 may perform at least a remaining portion of the block diagram 400. For example, in some embodiments, the device and the other computing device may perform the block diagram 400 in conjunction. That is, the device may perform a portion of the block diagram 400 and a remaining portion of the block diagram 400 may be performed by one or more other computing devices.

In some embodiments, the block diagram 400 depicted in FIG. 4 may be used to implement the process flow 300 described with reference to FIG. 3 and may include additional features not mentioned above.

The processor 430 of FIG. 4 may include and/or may be similar in many respects to the ISP 130 described above with reference to FIG. 1, and may include additional features not mentioned above. Consequently, repeated descriptions of the processor 430 described above with reference to FIG. 1 may be omitted for the sake of brevity.

As shown in FIG. 4, the processor 430 may obtain a first frame 410 from a first (or main) camera of a device (e.g., the camera module 100). The first frame 410 may correspond to the first frame 320 described above with reference to FIG. 3.

The processor 430 may provide the first frame 410 to a motion estimator component 440 to determine an angular motion (or velocity) of the first frame 410. As described above with reference to FIG. 3, the motion estimator component 440 may utilize various approaches for determining the angular velocity that may include, but not be limited to, SLAM algorithms, PSLAM algorithm, optical flow operations, motion estimation operations, or the like.

In addition, the processor 430 may provide AE statistics 415 of the first frame 410 to the auto exposure component 460.

The motion estimator component 440 may provide the determined angular velocity of the first frame 410 to an AE statistics selector component 450 that may select an ROI of a second frame based on the angular velocity. The second frame selected by the AE statistics selector component 450 may correspond to the second frame 330 described above with reference to FIG. 3.

The AE statistics selector component 450 may obtain UW statistics 425 corresponding to the ROI of the second frame from a reduced functionality ROI 420. The reduced functionality ROI 420 may correspond to a FOV of the first camera and/or the second camera and may include the ROI of the second frame. The UW statistics 425 may only include reduced functionality information (e.g., a histogram, a binned readout, a low-resolution image, or the like). That is, the UW statistics 425 may be obtained by the AE statistics selector component 450 when the image sensor (e.g., the first camera and/or the second camera) is operating a reduced functionality (e.g., assist) mode. The UW statistics 425 of FIG. 4 may correspond to the AE statistics 340 of FIG. 3. The AE statistics selector component 450 may provide the UW statistics 425 to the auto exposure component 460.

The auto exposure component 460 may extract auto-exposure information corresponding to the second frame. Alternatively or additionally, the auto exposure component 460 may adjust the auto-exposure information corresponding to the second frame based on differences between the AE statistics 415 of the first frame 410 and the UW statistics 425. The auto exposure component 460 may configure the first camera to capture the second frame based on the auto-exposure information. The processor 430 may output the captured second frame as the output image 435.

Although FIG. 4 depicts the processor 430 as a single processor for the sake of convenience, the present disclosure is not limited in this regard. For example, the processor 430 may be and/or may include one or more processors that may, individually or collectively, execute loaded instructions. Alternatively or additionally, at least one of the motion estimator component 440, the AE statistics selector component 450, and the AE component 460 may each be implemented by dedicated hardware including one or more of logic gates or circuits, registers, memories, interface circuits, or the like that may be configured to perform the above-described functions in association with the processor 430.

In addition, the number and arrangement of components shown in FIG. 4 are provided as an example. In practice, there may be additional components, fewer components, different components, or differently arranged components than those shown in FIG. 4. Furthermore, two (2) or more components shown in FIG. 4 may be implemented within a single component, or a single component shown in FIG. 4 may be implemented as multiple, distributed components. Alternatively or additionally, a set of (one or more) components shown in FIG. 4 may perform one or more functions described as being performed by another set of components shown in FIG. 4.

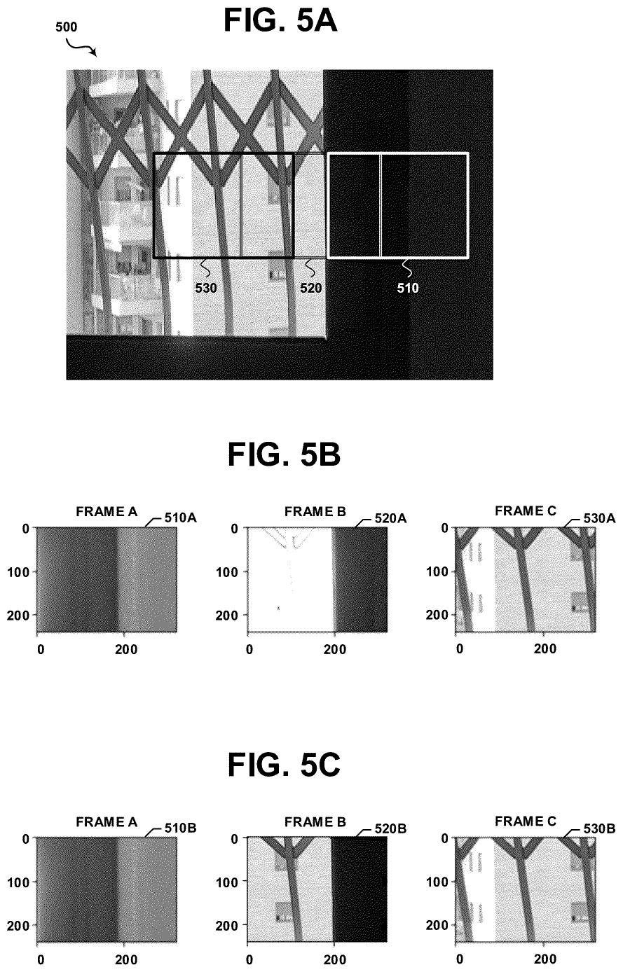

FIGS. 5A to 5C illustrate an example of performing auto-exposure precognition, in accordance with various aspects of the present disclosure.

Referring to FIGS. 5A to 5C, an auto-exposure precognition process 500 that implements one or more aspects of the disclosure is illustrated. In some embodiments, at least a portion of the auto-exposure precognition process 500 may be performed by a device (e.g., the camera module 100), which may include the auto-exposure precognition component 150. Alternatively or additionally, another computing device (e.g., a server, a laptop, a smartphone, a UE, a camera, a wearable device, a smart device, an IoT device, or the like) that includes the auto-exposure precognition component 150 may perform at least a remaining portion of the auto-exposure precognition process 500. For example, in some embodiments, the device and the other computing device may perform the auto-exposure precognition process 500 in conjunction. That is, the device may perform a portion of the auto-exposure precognition process 500 and a remaining portion of the auto-exposure precognition process 500 may be performed by one or more other computing devices.

The auto-exposure precognition process 500 depicted in FIGS. 5A to 5C may include and/or may be similar in many respects to the process flow 300 described above with reference to FIG. 3, and may include additional features not mentioned above. Consequently, repeated descriptions of the auto-exposure precognition process 500 described above with reference to FIG. 3 may be omitted for the sake of brevity.

Referring to FIG. 5A, an imaging sensor and/or a camera module (e.g., camera module 100 or image sensor 200) may capture a first frame 510 (represented in FIG. 5A by a solid white rectangle). The first frame 510 may correspond to first frames 320 and 410 described above with reference to FIGS. 3 and 4, respectively. As shown in FIG. 5A, the first frame 510 may be a relatively dark frame of the interior of a room.

As further shown in FIG. 5A, the subsequent frames to the first frame 510, namely, a second frame 520 (represented in FIG. 5A by a double line rectangle) and a third frame 530 (represented in FIG. 5A by a solid black line rectangle) may be relatively bright frames of the exterior of the room captured through a window. The second frame 520 and the third frame 530 may correspond to the second frame 330 described above with reference to FIG. 3.

Referring to FIG. 5B, example results from a related auto-exposure algorithms are illustrated in which the first frame 510A and the third frame 530A are properly exposed. However, the second frame 520A is over saturated because the related auto-exposure algorithm was unable to account for the sudden change in exposure between the first frame 510A and the second frame 520A.

Referring to FIG. 5C, example results from an auto-exposure precognition performed in accordance with various aspects of the present disclosure are illustrated. As shown in FIG. 50, the first frame 510B, the second frame 520B, and the third frame 530B are properly exposed because the auto-exposure precognition algorithm described herein was able to compensate for the sudden in exposure between the first frame 510B and the second frame 520B.

Advantageously, the methods, apparatuses, systems, and non-transitory computer-readable mediums for performing auto-exposure precognition, described above with reference to FIGS. 1 to 5C, may provide an auto-exposure functionality that may compensate for scene changes between frames that may significantly affect the optimal exposure of a given frame. Thus, the aspects presented herein may provide for devices and/or services that may reduce and/or avoid a need for auto-exposure algorithms to hunt for a predicted exposure configuration by adjusting the exposure configuration in anticipation of exposure changes in the scene that may still not be visible to the main camera.

Furthermore, aspects presented herein provide for a reduced functionality operational mode of a secondary camera (e.g., a high zoom and/or ultra-wide camera) used for obtaining the predicted exposure information without incurring increases in power consumption and/or processing load. The aspects described herein may also be applicable to other image capture and/or processing technologies and the standards that employ these technologies.

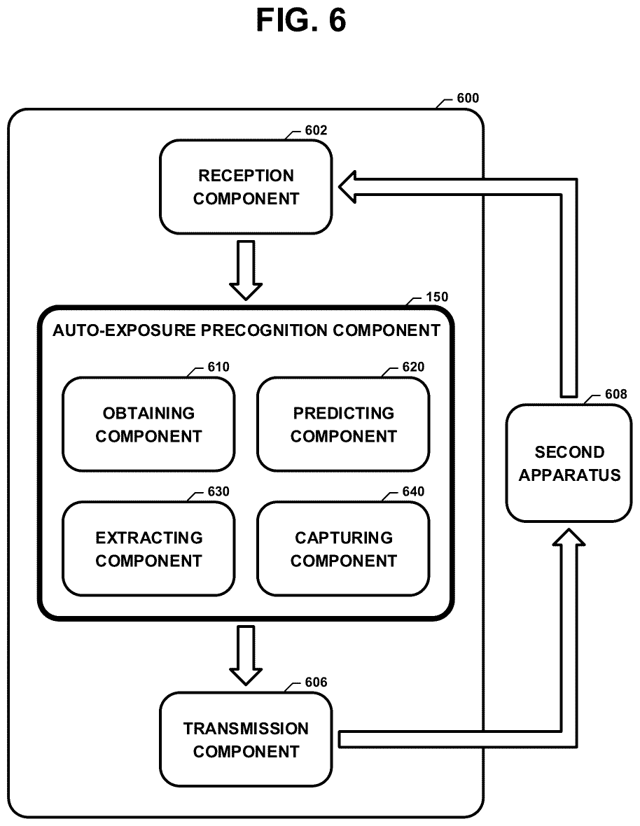

FIG. 6 illustrates a block diagram of an example apparatus for performing auto-exposure precognition, in accordance with various aspects of the present disclosure. The apparatus 600 may be a computing device (e.g., a server, a laptop, a smartphone, a UE, a camera, a wearable device, a smart device, an IoT device, or the like) and/or a computing device may include the apparatus 600. In some embodiments, the apparatus 600 may include a reception component 602 configured to receive communications (e.g., wired, wireless) from another apparatus (e.g., a second apparatus 608), an auto-exposure precognition component 150 configured to perform auto-exposure precognition, and a transmission component 606 configured to transmit communications (e.g., wired, wireless) to another apparatus (e.g., the second apparatus 608). The components of the apparatus 600 may be in communication with one another (e.g., via one or more buses or electrical connections). As shown in FIG. 6, the apparatus 600 may be in communication with the second apparatus 608 (e.g., a server, a laptop, a smartphone, a UE, a camera, a wearable device, a smart device, an IoT device, or the like) using the reception component 602 and/or the transmission component 606.

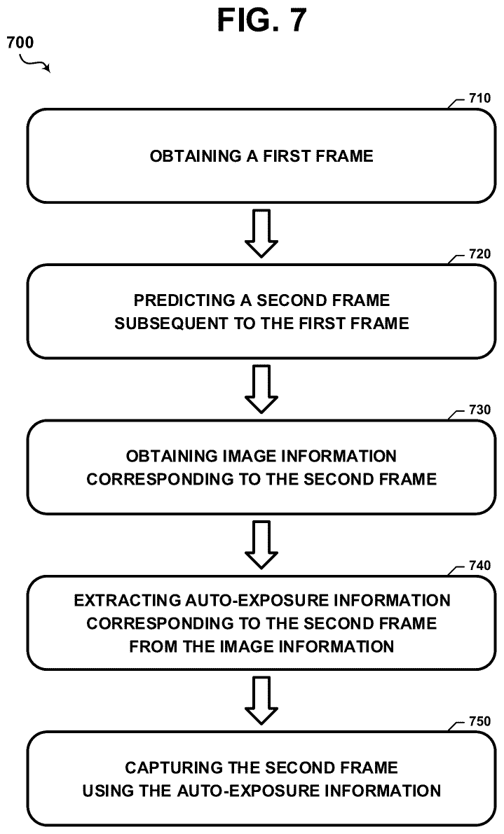

In some embodiments, the apparatus 600 may be configured to perform one or more operations described herein in connection with FIGS. 1 to 5C. Alternatively or additionally, the apparatus 600 may be configured to perform one or more processes described herein, such as method 700 of FIG. 7. In some embodiments, the apparatus 600 may include one or more components of the camera module 100 described with reference to FIG. 1.

The reception component 602 may receive communications, such as control information, data communications, or a combination thereof, from the second apparatus 608 (e.g., a server, a laptop, a smartphone, a UE, a camera, a wearable device, a smart device, an IoT device, or the like). The reception component 602 may provide received communications to one or more other components of the apparatus 600, such as the auto-exposure precognition component 150. In some embodiments, the reception component 602 may perform signal processing on the received communications, and may provide the processed signals to the one or more other components. In some embodiments, the reception component 602 may include one or more antennas, a receive processor, a controller/processor, a memory, or a combination thereof.

The transmission component 606 may transmit communications, such as control information, data communications, or a combination thereof, to the second apparatus 608 (e.g., a server, a laptop, a smartphone, a UE, a camera, a wearable device, a smart device, an IoT device, or the like). In some embodiments, the auto-exposure precognition component 150 may generate communications and may transmit the generated communications to the transmission component 606 for transmission to the second apparatus 608. In some embodiments, the transmission component 606 may perform signal processing on the generated communications, and may transmit the processed signals to the second apparatus 608. In other embodiments, the transmission component 606 may include one or more antennas, a transmit processor, a controller/processor, a memory, or a combination thereof. In some embodiments, the transmission component 606 may be co-located with the reception component 602 such as in a transceiver and/or a transceiver component.

The auto-exposure precognition component 150 may be configured to perform auto-exposure precognition. In some embodiments, the auto-exposure precognition component 150 may include a set of components, such as an obtaining component 610 configured to obtain a first frame and image information corresponding to a second frame, a predicting component 620 configured to predict a second frame subsequent to the first frame, an extracting component 630 configured to extract auto-exposure information corresponding to the second frame from the image information, and a capturing component 640 configured to capture the second frame using the auto-exposure information.

In some embodiments, the set of components may be separate and distinct from the auto-exposure precognition component 150. In other embodiments, one or more components of the set of components may include or may be implemented within a controller/processor (e.g., the ISP 130, the processor 430), a memory (e.g., the memory 140), or a combination thereof, of the camera module 100 described above with reference to FIG. 1. Alternatively or additionally, one or more components of the set of components may be implemented at least in part as software stored in a memory, such as the memory 140. For example, a component (or a portion of a component) may be implemented as computer-executable instructions or code stored in a computer-readable medium (e.g., a non-transitory computer-readable medium) and executable by a controller or a processor to perform the functions or operations of the component.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally or alternatively, a set of (one or more) components shown in FIG. 6 may perform one or more functions described as being performed by another set of components shown in FIGS. 1 to 5C.

Referring to FIG. 7, in operation, an apparatus 600 may perform a method 700 of performing auto-exposure precognition. The method 700 may be performed by the camera module 100 (which may include the ISP 130 or the processor 430, and/or the memory 140, and which may be the entire camera module 100 and/or include one or more components of the camera module 100, such as the auto-exposure precognition component 150) and/or the apparatus 600. The method 700 may be performed by the camera module 100, the apparatus 600, and/or the auto-exposure precognition component 150 in communication with the second apparatus 608 (e.g., a server, a laptop, a smartphone, a UE, a camera, a wearable device, a smart device, an IoT device, or the like).

At block 710 of FIG. 7, the method 700 may include obtaining a first frame. For example, in an aspect, the camera module 100, the apparatus 600, the auto-exposure precognition component 150, and/or the obtaining component 610 may be configured to or may include means for obtaining a first frame 320.

In an embodiment, the obtaining at block 710 may include capturing the first frame 320 using a first camera having a first field-of-view (FoV).

In an optional or additional embodiment, the obtaining at block 710 may include obtaining a first portion of a FoV of a camera.

In an embodiment, a second camera having a second FoV different from the first FoV may obtain an image. The image may be out of the first FOV.

At block 720 of FIG. 7, the method 700 may include predicting a second frame subsequent to the first frame. For example, in an aspect, the camera module 100, the apparatus 600, the auto-exposure precognition component 150, and/or the predicting component 620 may be configured to or may include means for predicting a second frame 330 subsequent to the first frame 320.

In an embodiment, the predicting at block 720 may include predicting a second portion of the FoV of the camera.

In an optional or additional embodiment, the predicting at block 720 may include determining an angular motion of the first frame 320, and predicting a ROI of the second frame 330 based on the angular motion.

In another optional or additional embodiment, the determining of the angular motion may include obtaining, from a motion sensor of the apparatus, the angular motion.

In yet another optional or additional embodiment, the determining of the angular motion may include determining the angular motion of the first frame 320 by performing an optical flow operation on the first frame 320.

At block 730 of FIG. 7, the method 700 may include obtaining image information corresponding to the second frame. For example, in an aspect, the camera module 100, the apparatus 600, the auto-exposure precognition component 150, and/or the obtaining component 610 may be configured to or may include means for obtaining image information 340 corresponding to the second frame 330.

In an embodiment, the obtaining at block 730 may include obtaining the image information 340 using a second camera different from the first camera.

In an optional or additional embodiment, the first camera may have a first FoV, the second camera may have a second FoV, and the second FoV may be greater than the first FoV.

In another optional or additional embodiment, a first auto-exposure configuration of the first camera may be correlated to a second auto-exposure configuration of the second camera.

In yet another optional or additional embodiment, the obtaining at block 730 may include obtaining the image information 340 using the second camera operating in a reduced functionality mode.

At block 740 of FIG. 7, the method 700 may include extracting auto-exposure information corresponding to the second frame from the image information. For example, in an aspect, the camera module 100, the apparatus 600, the auto-exposure precognition component 150, and/or the extracting component 630 may be configured to or may include means for extracting auto-exposure information 350 corresponding to the second frame 330 from the image information 340.

In an embodiment, the extracting at block 740 may include adjusting the auto-exposure information 350 corresponding to the second frame 330 based on a difference between the first auto-exposure configuration and the second auto-exposure configuration.

In an optional or additional embodiment, the extracting at block 740 may include adjusting the auto-exposure information 350 based on a difference between a pixel response and a pixel size of the first camera and a pixel response and a pixel size of the second camera.

In another optional or additional embodiment, the extracting at block 740 may include adjusting the auto-exposure information 350 based on a difference between a responsivity of the first camera and a responsivity of the second camera.

At block 750 of FIG. 7, the method 700 may include capturing the second frame using the auto-exposure information. For example, in an aspect, the camera module 100, the apparatus 600, the auto-exposure precognition component 150, and/or the capturing component 640 may be configured to or may include means for capturing the second frame 330 using the auto-exposure information 350.

In an embodiment, the capturing at block 750 may include capturing the second frame 330 using the first camera configured with the auto-exposure information 350.

The following aspects are illustrative only and aspects thereof may be combined with aspects of other embodiments or teaching described herein, without limitation.

Aspect 1 is a method for performing auto-exposure precognition by an apparatus. The method includes obtaining a first frame, predicting a second frame subsequent to the first frame, obtaining image information corresponding to the second frame, extracting auto-exposure information corresponding to the second frame from the image information, and capturing the second frame using the auto-exposure information.

In Aspect 2, the obtaining of the first frame of the method of Aspect 1 may include capturing the first frame using a first camera, and the capturing of the second frame may include capturing the second frame using the first camera configured with the auto-exposure information.

In Aspect 3, the obtaining of the first frame of the method of any of Aspects 1 or 2 may include capturing the first frame using a first camera, and the obtaining of the image information may include obtaining the image information using a second camera different from the first camera.

In Aspect 4, in the method of any of Aspects 1 to 3, the first camera may have a first FoV, the second camera may have a second FoV, and the second FoV may be greater than the first FoV.

In Aspect 5, in the method of any of Aspects 1 to 4, a first auto-exposure configuration of the first camera may be correlated to a second auto-exposure configuration of the second camera.

In Aspect 6, the extracting of the auto-exposure information of the method of any of Aspects 1 to 5 may include adjusting the auto-exposure information corresponding to the second frame based on a difference between the first auto-exposure configuration and the second auto-exposure configuration.

In Aspect 7, the obtaining of the image information of the method of any of Aspects 1 to 6 may include obtaining the image information using the second camera operating in a reduced functionality mode.

In Aspect 8, the extracting of the auto-exposure information of the method of any of Aspects 1 to 7 may include adjusting the auto-exposure information based on at least one of a first difference between a pixel response and a pixel size of the first camera and a pixel response and a pixel size of the second camera, or a second difference between a responsivity of the first camera and a responsivity of the second camera.

In Aspect 9, the obtaining of the first frame of the method of any of Aspects 1 to 8 may include obtaining a first portion of a FoV of a camera, and the predicting of the second frame may include predicting a second portion of the FoV of the camera.

In Aspect 10, the predicting of the second frame of the method of any of Aspects 1 to 9 may include determining an angular motion of the first frame, and predicting an ROI of the second frame based on the angular motion.

In Aspect 11, the determining of the angular motion of the method of any of Aspects 1 to 10 may include obtaining, from a motion sensor of the apparatus, the angular motion.

In Aspect 12, the determining of the angular motion of the method of any of Aspects 1 to 10 may include determining the angular motion of the first frame by performing an optical flow operation on the first frame.

Aspect 13 is an apparatus for performing auto-exposure precognition. The apparatus includes a memory storing instructions, and one or more processors communicatively coupled to the memory. The instructions are configured to, when individually or collectively executed by the one or more processors, cause the apparatus to perform one or more of the methods of any of Aspects 1 to 12.

Aspect 14 is an apparatus for performing auto-exposure precognition. The apparatus includes means for performing one or more of the methods of any of Aspects 1 to 12.

Aspect 15 is a non-transitory computer-readable storage medium storing computer-executable instructions for performing auto-exposure precognition by a device. The computer-executable instructions are configured to, when executed individually or collectively by at least one processor of the device, cause the device to perform one or more of the methods of any of Aspects 1 to 12.

Aspect 16 is an electronic device that includes an imaging sensor, a memory, and one or more processors communicatively coupled to the imaging sensor and to the memory. The imaging sensor is configured to obtain a first frame, predict a second frame subsequent to the first frame, and obtain image information corresponding to the second frame. The instructions are configured to, when individually or collectively executed by the one or more processors, cause the electronic device to obtain, from the imaging sensor, the first frame and the image information, extract auto-exposure information corresponding to the second frame from the image information, and capture, using the imaging sensor, the second frame using the auto-exposure information. The instructions are further configured to cause the electronic device to perform one or more of the methods of any of Aspects 1 to 12.

The foregoing disclosure provides illustration and description, but may not be intended to be exhaustive or to limit the implementations to the precise form disclosed. Modifications and variations are possible in light of the above disclosure or may be acquired from practice of the implementations.

For example, the terms “component,” “module,” “system” or the like are intended to include a computer-related entity, such as but not limited to hardware, firmware, a combination of hardware and software, software, or software in execution. For example, a component may be, but may not be limited to being, a process running on a processor, a processor, an object, an executable, a thread of execution, a program, and/or a computer. By way of illustration, both an application running on a computing device and the computing device may be a component. One or more components may reside within a process and/or thread of execution and a component may be localized on one computer and/or distributed between two or more computers. In addition, these components may execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Some embodiments may relate to a system, a method, and/or a computer readable medium at any possible technical detail level of integration. The computer readable medium may include a computer-readable non-transitory storage medium (or media) having computer readable program instructions thereon for causing a one or more processors to carry out operations. Non-transitory computer-readable media may exclude transitory signals.

The computer readable storage medium may be a tangible device that may retain and store instructions for use by an instruction execution device. The computer readable storage medium may be, for example, but may not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EEPROM or Flash memory), a static random access memory (SRAM), a portable compact disc read-only memory (CD-ROM), a DVD, a memory stick, a floppy disk, a mechanically encoded device such as punch-cards or raised structures in a groove having instructions recorded thereon, and any suitable combination of the foregoing. A computer readable storage medium, for example, may not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local-area network (LAN) or a wide-area network (WAN), or the connection may be made to an external computer (for example, through the Internet using an internet service provider). In some embodiments, electronic circuitry including, for example, programmable logic circuitry, field programmable gate arrays (FPGA), and/or programmable logic arrays (PLA) may execute the computer readable program instructions by utilizing state information of the computer readable program instructions to personalize the electronic circuitry, in order to perform aspects or operations.

These computer readable program instructions may be provided to a one or more processors of a general purpose computer, special purpose computer, or other programmable data processing apparatus to produce a machine, such that the instructions, which execute individually or collectively via the one or more processors of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

At least one of the components, elements, modules or units (collectively “components” in this paragraph) represented by a block in the drawings may be embodied as various numbers of hardware, software and/or firmware structures that execute respective functions described above, according to an example embodiment. According to example embodiments, at least one of these components may use a direct circuit structure, such as a memory, a processor, a logic circuit, a look-up table, or the like, that may execute the respective functions through controls of one or more microprocessors or other control apparatuses. Also, at least one of these components may be specifically embodied by a module, a program, or a part of code, which may contain one or more executable instructions for performing specified logic functions, and may be executed by one or more microprocessors or other control apparatuses. Further, at least one of these components may include or may be implemented by a processor such as a central processing unit (CPU) that may perform the respective functions, a microprocessor, or the like. Two or more of these components may be combined into one single component which performs all operations or functions of the combined two or more components. Also, at least part of functions of at least one of these components may be performed by another of these components. Functional aspects of the above example embodiments may be implemented in algorithms that execute on one or more processors. Furthermore, the components represented by a block or processing steps may employ any number of related art techniques for electronics configuration, signal processing and/or control, data processing or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

The flowchart and block diagrams in the drawings illustrate the architecture, functionality, and operation of possible implementations of systems, methods, and computer readable media according to various embodiments. In this regard, each block in the flowchart or block diagrams may represent a module, segment, or portion of instructions, which includes one or more executable instructions for implementing the specified logical functions. The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It may also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

It may be apparent that systems and/or methods, described herein, may be implemented in different forms of hardware, firmware, or a combination of hardware and software. The actual specialized control hardware or software code used to implement these systems and/or methods may not be limiting of the implementations. Thus, the operation and behavior of the systems and/or methods were described herein without reference to specific software code—it being understood that software and hardware may be designed to implement the systems and/or methods based on the description herein.

No element, act, or instruction described in the present disclosure should be construed as critical or essential unless explicitly described as such. Also, for example, the articles “a” and “an” may be intended to include one or more items, and may be used interchangeably with “one or more.” Furthermore, for example, the term “set” may be intended to include one or more items (e.g., related items, unrelated items, a combination of related and unrelated items, or the like), and may be used interchangeably with “one or more.” Where only one item may be intended, the term “one” or similar language may be used. Also, for example, the terms “has,” “have,” “having,” “includes,” “including,” or the like may be intended to be open-ended terms. Further, the phrase “based on” may be intended to mean “based, at least in part, on” unless explicitly stated otherwise. In addition, expressions such as “at least one of [A] and [B]” or “at least one of [A] or [B]” may be understood to include only A, only B, or both A and B.

Reference throughout this specification to “one embodiment,” “an embodiment,” or similar language may indicate that a particular feature, structure, or characteristic described in connection with the indicated embodiment may be included in at least one embodiment of the present solution. Thus, the phrases “in one embodiment”, “in an embodiment,” and similar language throughout this specification may, but do not necessarily, all refer to the same embodiment. For example, such terms as “1st” and “2nd,” or “first” and “second” may be used to simply distinguish a corresponding component from another, and does not limit the components in other aspects (e.g., importance or order). It may be understood that if an element (e.g., a first element) may be referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It may be understood that when an element or layer may be referred to as being “over,” “above,” “on,” “below,” “under,” “beneath,” “connected to” or “coupled to” another element or layer, it may be directly over, above, on, below, under, beneath, connected or coupled to the other element or layer or intervening elements or layers may be present. In contrast, when an element may be referred to as being “directly over,” “directly above,” “directly on,” “directly below,” “directly under,” “directly beneath,” “directly connected to” or “directly coupled to” another element or layer, there are no intervening elements or layers present.

The descriptions of the various aspects and embodiments have been presented for purposes of illustration, but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations may be apparent to those of ordinary skill in the art without departing from the scope of the described embodiments. The terminology used herein may be chosen to best explain the principles of the embodiments, the practical application or technical improvement over technologies found in the marketplace, or to enable others of ordinary skill in the art to understand the embodiments disclosed herein.

It may be understood that the specific order or hierarchy of blocks in the processes/flowcharts disclosed are an illustration of exemplary approaches. Based upon design preferences, it may be understood that the specific order or hierarchy of blocks in the processes/flowcharts may be rearranged. Further, some blocks may be combined and/or omitted. The accompanying claims present elements of the various blocks in a sample order, and are not meant to be limited to the specific order or hierarchy presented.

Furthermore, the described features, advantages, and characteristics of the present disclosure may be combined in any suitable manner in one or more embodiments. One skilled in the relevant art may recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

What is claimed is:

1. A method for performing auto-exposure precognition by an apparatus, the method comprising:
obtaining, by a first camera having a first field-of-view (FoV), a first frame;
obtaining, by a second camera having a second FOV different from the first FoV, an image;
predicting, by an auto-exposure precognition component, a second frame subsequent to the first frame based on the image;
obtaining, by the auto-exposure precognition component, image information corresponding to the second frame;
extracting, by the auto-exposure precognition component, auto-exposure information corresponding to the second frame from the image information; and
capturing, by the first camera, the second frame using the auto-exposure information.

2. The method of claim 1, wherein the second FoV is greater than the first FoV.

3. The method of claim 2, wherein the image is out of the first FOV.

4. The method of claim 3, wherein the second FoV is between 70 degree and 100 degree.

5. The method of claim 3, wherein a first auto-exposure configuration of the first camera is correlated to a second auto-exposure configuration of the second camera.

6. The method of claim 5, wherein the extracting of the auto-exposure information comprises adjusting the auto-exposure information corresponding to the second frame based on a difference between the first auto-exposure configuration and the second auto-exposure configuration.

7. The method of claim 3, wherein the obtaining of the image information comprises obtaining the image information using the second camera operating in a reduced functionality mode.

8. The method of claim 3, wherein the extracting of the auto-exposure information comprises adjusting the auto-exposure information based on at least one of:
a first difference between a pixel response and a pixel size of the first camera and a pixel response and a pixel size of the second camera; or
a second difference between a responsivity of the first camera and a responsivity of the second camera.

9. The method of claim 1, wherein the second FoV is greater than 100 degree.

10. The method of claim 1, wherein the predicting of the second frame comprises:
determining, by a predicting component, an angular motion of the first frame; and
predicting, by the predicting component, a region-of-interest (ROI) of the second frame based on the angular motion.

11. The method of claim 10, wherein the determining of the angular motion comprises:
obtaining, from a motion sensor of the apparatus, the angular motion.

12. The method of claim 10, wherein the determining of the angular motion comprises:
determining the angular motion of the first frame by performing an optical flow operation on the first frame.

13. An apparatus for performing auto-exposure precognition, the apparatus comprising:
a memory storing instructions; and
one or more processors communicatively coupled to the memory,
wherein the instructions are configured to, when individually or collectively executed by the one or more processors, cause the apparatus to:
obtain, by a first camera having a first field-of-view (FoV), a first frame;
obtaining, by a second camera having a second FoV different from the first FoV, an image;
predict, by an auto-exposure precognition component, a second frame subsequent to the first frame based on the image;
obtain, by the auto-exposure precognition component, image information corresponding to the second frame;
extract, by the auto-exposure precognition component, auto-exposure information corresponding to the second frame from the image information; and
capture, by the first camera, the second frame using the auto-exposure information.

14. The apparatus of claim 13,
wherein the instructions are further configured to, when individually or collectively executed by the one or more processors, cause the apparatus to:
capture, by the first camera, the first frame; and
obtain, by the auto-exposure precognition component operating in a reduced functionality mode, the image information.

15. The apparatus of claim 14, wherein the second FoV is between 70 degree and 100 degree.

16. The apparatus of claim 14, wherein a first auto-exposure configuration of the first camera is correlated to a second auto-exposure configuration of the second camera.

17. The apparatus of claim 16, wherein the instructions are further configured to, when individually or collectively executed by the one or more processors, cause the apparatus to:
adjust the auto-exposure information based on at least one of:
a first difference between the first auto-exposure configuration and the second auto-exposure configuration;
a second difference between a pixel response and a pixel size of the first camera and a pixel response and a pixel size of the second camera; or
a third difference between a responsivity of the first camera and a responsivity of the second camera.

18. The apparatus of claim 13, wherein the second FoV is greater than 100 degree.

19. The apparatus of claim 13, wherein the instructions are further configured to, when individually or collectively executed by the one or more processors, cause the apparatus to:
determine, by a predicting component, an angular motion of the first frame; and
predict, by the predicting component, a region-of-interest (ROI) of the second frame based on the angular motion.

20. An electronic device, the electronic device comprising:
an imaging sensor configured to:
obtain a first frame;
predict a second frame subsequent to the first frame; and
obtain image information corresponding to the second frame;
a memory storing instructions; and
one or more processors communicatively coupled to the imaging sensor and to the memory,
wherein the instructions are configured to, when individually or collectively executed by the one or more processors, cause the electronic device to:
obtain, from the imaging sensor, the first frame and the image information;
extract auto-exposure information corresponding to the second frame from the image information; and
capture, using the imaging sensor, the second frame using the auto-exposure information.
